(19) United States
(12) Patent Application Publication
(10) Pub. No.: US 2025/0317482 A1
(43) Pub. Date: Oct. 9, 2025

(54) APPLICATION CONTROLLED MODIFICATION OF PRIORITY TRANSITION CONTENT OUTPUT

(71) Applicant: TOYOTA JIDOSHA KABUSHIKI KAISHA, Aichi-ken (JP)

(72) Inventors: Toshiyuki AGA, Ota-ku (JP); Hideto KIMURA, Kobe-shi (JP)

(21) Appl. No.: 18/628,648

(22) Filed: Apr. 5, 2024

(51) Int. Cl. H04L 65/4038; G06F 3/16; H04L 65/1089; H04L 65/402

(52) U.S. Cl. CPC H04L 65/4038; G06F 3/165; H04L 65/1089; H04L 65/402

(57) ABSTRACT

Application controlled modification of priority transition content output is performed by determining that an application has lost priority while the application is transmitting output, assigning standby status to the application, recording display output and audio output generated by the application, modifying, in response to a request from the application, the recording of output generated by the application, and replaying content of the recording in response to determining that the application has priority.

### BACKGROUND

An output device installed in a vehicle, such as a speaker, display, etc., is used by a plurality of applications. Some applications are non-flutter applications, which produce constant audio streams from radio, prerecorded physical media, internet, etc. Some applications are flutter applications, which produce intermittent audio data for navigation, warnings, etc. At any given time, more than one application may transmit requests for output by an audio output device or a video output device, such as a touch screen.

In a vehicle entertainment system, where multiple applications vie for priority of output devices, priority is arbitrated and assigned in real-time, such that the application holding priority, and therefore currently outputting, may constantly change. When an application loses priority, the application continues to produce content for output. When the application regains priority, output of the content resumes.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for application controlled modification of priority transition content output, according to at least some embodiments of the subject disclosure.

FIG. 2 is an operational flow for application controlled modification of priority transition content output, according to at least some embodiments of the subject disclosure.

FIG. 3 is an operational flow for modifying recorded output, according to at least some embodiments of the subject disclosure.

FIG. 4 is a block diagram of a hardware configuration for application controlled modification of priority transition content output, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In some vehicles known to the inventors, content produced while the application did not hold priority is lost. At least some embodiments of the subject disclosure mitigate content loss by recording content produced while an application does not hold priority. In at least some embodiments, when an application loses priority, content for output that continues to be produced is recorded. In at least some embodiments, when the application regains priority, the recorded content as modified in a manner determined to be appropriate by the application is replayed.

In at least some embodiments, each application determines the portion of the recording that is appropriate for replay. In at least some embodiments, application controlled modification of priority transition content output results in a more effective and computationally efficient determination of an appropriate portion of recorded content to replay.

In at least some embodiments, the arbitration manager judges priority between applications. In at least some embodiments, this judgement is based on the mediation rule stored in a Rules Based Automation (RBA) mediation library. In at least some embodiments, the arbitration manager considers screen output, basic sound output, and interrupt sound output. In at least some embodiments, the arbitration manager resolves conflicts between applications. In at least some embodiments, the judgement result is sent to each application via an application manager.

In at least some embodiments, the arbitration manager confirms whether to perform mediation or not. In at least some embodiments, this confirmation occurs in response to a mediation request coming from an application other than a privileged application. In at least some embodiments, the privileged application has stronger mediation authority than that of the arbitration manager.

In at least some embodiments, the arbitration manager stores a screen output, a base sound output, and/or an interrupted sound. In at least some embodiments, these outputs are an ongoing recording of the application which receives “standby” status as the result of mediation. In at least some embodiments, the arbitration manager provides the application with opportunities for acquiring, modifying, updating or deleting the ongoing recording.

In at least some embodiments, the arbitration manager stores a final screen/sound output. In at least some embodiments, this output is a last condition of the application which receives “inactive” status as the result of mediation. In at least some embodiments, the arbitration manager provides the application with a means for acquiring, updating or deleting the last condition.

In at least some embodiments, the arbitration manager does not determine how to handle recordings, such as based on individual application or application-type settings. In at least some embodiments, the arbitration manager enables each application to acquire, modify, update, or delete the recording or condition. In at least some embodiments, the arbitration manager also enables each application to change a status from standby to inactive. In at least some embodiments, an application ceases to generate content for output in inactive status.

In at least some embodiments, in response to an application having lower priority, the arbitration manager puts the application into standby status. In at least some embodiments, the arbitration manager begins recording any display output and audio output generated by the application. In at least some embodiments, in response to an application request, the arbitration manager stops recording display and audio output. In at least some embodiments, the arbitration manager preserves the last condition. In at least some embodiments, in response to an application request, the arbitration manager puts the application into inactive status from standby status. In at least some embodiments, the arbitration manager stops recording and preserves the last condition. In at least some embodiments, in response to an application request, the arbitration manager updates the recording. In at least some embodiments, the arbitration manager removes all but the latest 5 seconds. In at least some embodiments, in response to an application request, the arbitration manager deletes the recording and last condition. In at least some embodiments, in response to an application request, the arbitration manager transmits the recording or condition for review by the application. In at least some embodiments, in response to the arbitration manager determining that the application has highest priority, the recording or the last condition is output. In at least some embodiments, in response to the recording being output, recording continues through a buffer.

In at least some embodiments, in response to applications returning to highest audio priority, applications determine the best content to output. In at least some embodiments, radio applications playback what was missed. In at least some embodiments, map applications skip what was missed and jump straight to the most current content.

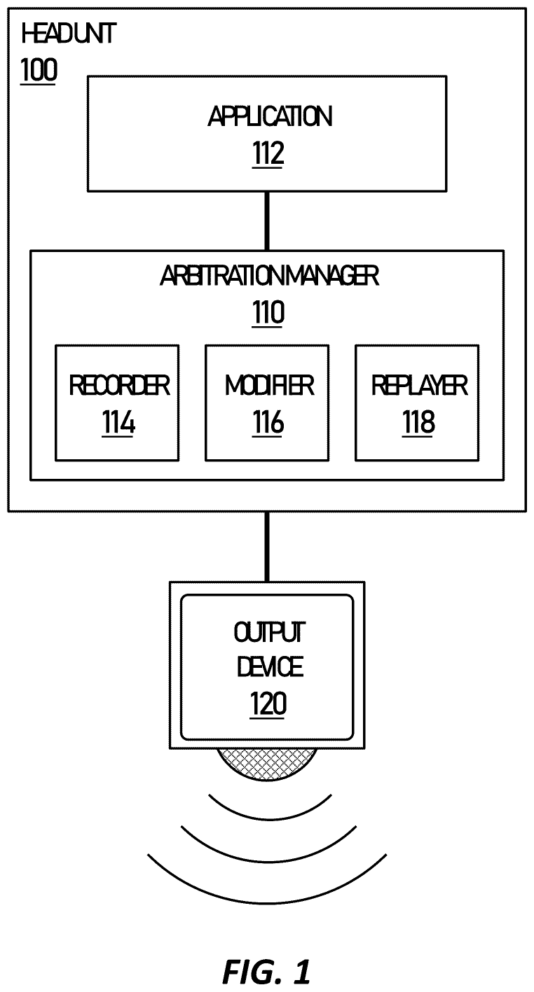

FIG. 1 is a schematic diagram of a system for application controlled modification of priority transition content output, according to at least some embodiments of the subject disclosure. In at least some embodiments, the system is within an automobile or other vehicle. The system includes head unit 100 and output device 120.

Head unit 100 is in communication with output device 120, and includes arbitration manager 110 and application 112. In at least some embodiments, head unit 100 is the central component of a vehicle entertainment system. In at least some embodiments, head unit 100 is configured to host and execute the functions of arbitration manager 110 and application 112. In at least some embodiments, head unit 100 is configured to control content transmitted to output device 120. In at least some embodiments, head unit 100 comprises a microcontroller unit (MCU), a microprocessor unit (MPU), an electronic controller unit (ECU), which is configured to execute instructions stored in a memory component. In at least some embodiments, head unit 100 comprises a memory component, such as random access memory (RAM), read-only memory (ROM), or flash memory, which is configured to store instructions and data. In at least some embodiments, head unit 100 comprises a storage component, such as a hard disk drive (HDD) or a solid-state drive (SSD), which is configured to store data long-term. In at least some embodiments, head unit 100 comprises an input/output (I/O) interface, which is configured to communicate with external devices, such as output device 120. In at least some embodiments, head unit 100 is an embedded system specifically designed for vehicles, such as vehicle entertainment system.

Arbitration manager 110 is in communication with application 112, and includes recorder 114, modifier 116, and replayer 118. In at least some embodiments, arbitration manager 110 manages the system's resources and provides services for software hosted by head unit 100. In at least some embodiments, arbitration manager 110 interacts with all other components of the vehicle, such as components outside of head unit 100. In at least some embodiments, arbitration manager 110 comprises a kernel, which is configured to manage the resources of head unit 100, such as a CPU, memory, and I/O devices. In at least some embodiments, arbitration manager 110 comprises a file system, which is configured to organize and manage files on the storage device, such as files of recorded output and modifications thereof.

Application 112 is in communication with arbitration manager 110. In at least some embodiments, application 112 produces content for output. In at least some embodiments, application 112 produces content to be recorded. In at least some embodiments, application 112 interacts with arbitration manager 110, recorder 114, and replayer 118. In at least some embodiments, application 112 comprises a user interface, which is configured to receive instructions from a user. In at least some embodiments, application 112 includes instructions or rules for modifying a recording that is appropriate for replay. In at least some embodiments, application 112 includes instructions or rules for determining a portion of a recording that is appropriate for replay. In at least some embodiments, application 112 is any software that runs on head unit 100 and produces output, such as for navigation, media presentation, emergency guidance, user communication, etc.

In at least some embodiments, recorder 114 records output of application 112. In at least some embodiments, recorder 114 interacts with application 112. In at least some embodiments, recorder 114 comprises a capture module, which is configured to capture the output of application 112. In at least some embodiments, recorder 114 comprises a storage module, which is configured to store the captured output in a memory or storage device. In at least some embodiments, recorder 114 is a software module that is part of arbitration manager 110 or a separate application.

In at least some embodiments, modifier 116 modifies the recorded output in response to a request from application 112. In at least some embodiments, modifier 116 interacts with application 112. In at least some embodiments, modifier 116 comprises a processing module, which is configured to process the recorded output and apply modifications. In at least some embodiments, modifier 116 is a software module that is part of arbitration manager 110 or a separate application.

In at least some embodiments, replayer 118 replays the recorded content. In at least some embodiments, replayer 118 interacts with application 112. In at least some embodiments, replayer 118 comprises a playback module, which is configured to read recorded content or modified content from a memory or storage device for transmission to an output device. In at least some embodiments, replayer 118 is a software module that is part of arbitration manager 110 or a separate application.

Output device 120 is in communication with head unit 100. In at least some embodiments, output device 120 is hardware that the system uses to replay recorded content or modified content to the user. In at least some embodiments, output device 120 includes speakers for audio output and a display for visual output. In at least some embodiments, output device 120 comprises a display, such as a liquid crystal display (LCD) or a light-emitting diode (LED) display, which is configured to display visual content. In at least some embodiments, output device 120 comprises a speaker, which is configured to output audio content. In at least some embodiments, output device 120 comprises an I/O interface, which is configured to communicate with head unit 100 and other components of the vehicle. In at least some embodiments, output device 120 includes built-in speakers and a touchscreen display integrated into the dashboard of a vehicle.

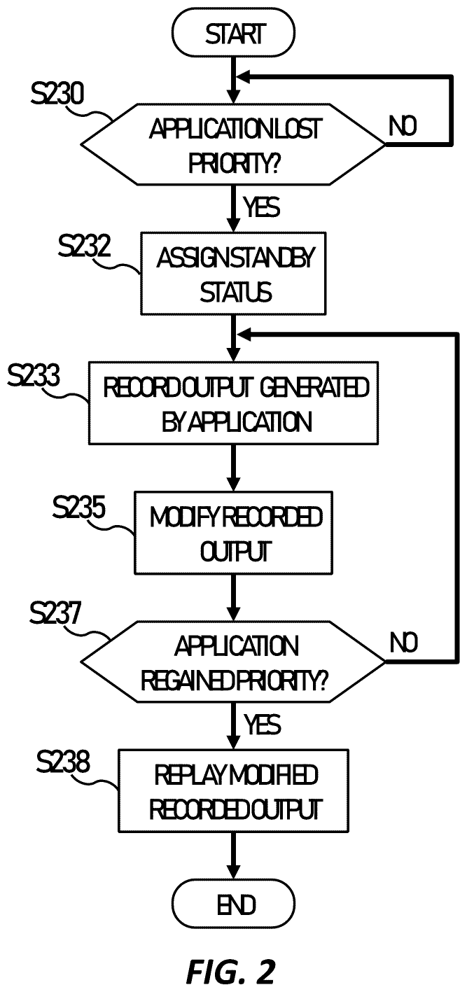

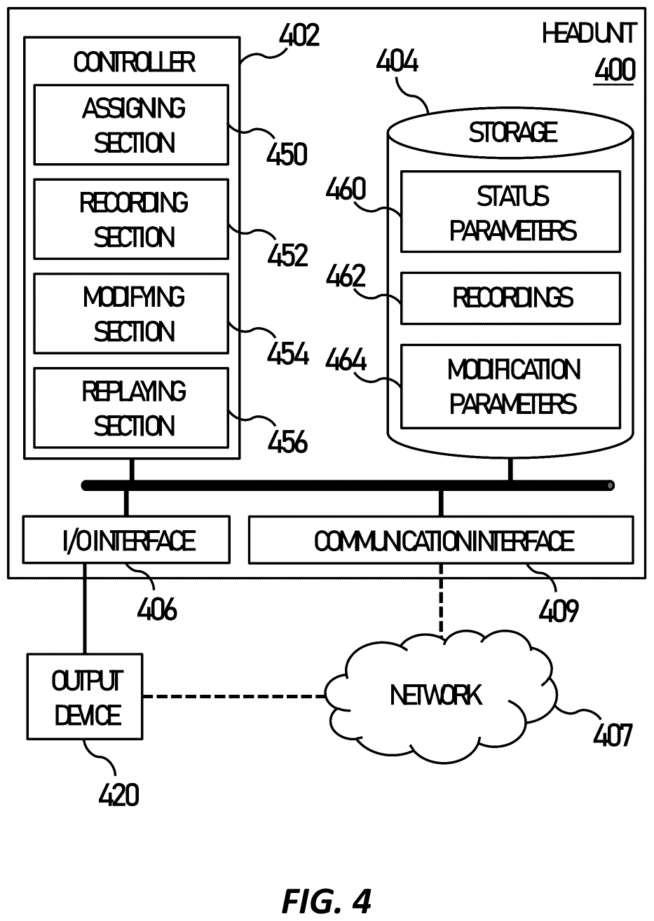

FIG. 2 is an operational flow for application controlled modification of priority transition content output, according to at least some embodiments of the subject disclosure. The operational flow provides a method of simultaneous audio output resulting from priority arbitration. In at least some embodiments, the method is performed by a controller, such as controller 402 of FIG. 4.

At S230, the controller determines whether an application has lost priority. In at least some embodiments, the controller determines that an application has lost priority while the application is transmitting output, In at least some embodiments, the controller interfaces with the operating system's process scheduler. In at least some embodiments, the controller uses system calls to query the scheduler and determine the current priority of the application. In at least some embodiments, the controller judges priority between applications. In at least some embodiments, this judgement is based on mediation rules stored in a Rules Based Automation (RBA) mediation library. In at least some embodiments, the controller considers screen output, basic sound output, and interrupt sound output in determining priority. In at least some embodiments, the arbitration manager resolves priority conflicts between applications. In response to the application losing priority, the operational flow proceeds to status assignment at S232. In response to the application not losing priority, the operational flow returns to priority determination at S230.

At S232, in at least some embodiments, an assigning section of the controller assigns standby status to the application. In at least some embodiments, the assigning section changes the application's state in the system's process table. In at least some embodiments, the assigning section uses system calls to modify the process table and set the application's state to standby. In at least some embodiments, the assigning section transmits the judgement result to the application via an application manager. In at least some embodiments, the assigning section notifies the application of the standby status via an application manager.

At S233, in at least some embodiments, a recording section of the controller records output generated by the application. In at least some embodiments, the recording section records display output and audio output generated by the application. In at least some embodiments, the recording section interfaces with the system's display and audio drivers. In at least some embodiments, the recording section uses system calls to capture the application's display and audio output and stores it in a buffer. In at least some embodiments, the recording section stores one or more of a screen output, a base sound output, or an interrupted sound. In at least some embodiments, these outputs are an ongoing recording of the application which receives “standby” status. In at least some embodiments, the recording section stores a final screen/sound output. In at least some embodiments, this output is a last condition of the application. In at least some embodiments, this recording is then available for modification by the recording modifier.

At S235, in at least some embodiments, a modifying section of the controller modifies recorded output. In at least some embodiments, the modifying section modifies, in response to a request from the application, the recording of output generated by the application. In at least some embodiments, the modifying section applies transformations to the data in the buffer. In at least some embodiments, the modifying section uses system calls to access the buffer and apply the requested modifications.

At S237, in at least some embodiments, the controller determines whether the application has regained priority. In at least some embodiments, the controller interfaces with the system's process scheduler, similar to the priority determiner. In at least some embodiments, the controller uses system calls to query the scheduler and determine the current priority of the application. In at least some embodiments, the controller determines whether the application has the priority in response to deactivation of transmission. In response to the application regaining priority, the operational flow proceeds to replay at S238. In response to the application not regaining priority, the operational flow returns to output recording at S233.

At S238, in at least some embodiments, a replaying section of the controller replays modified recorded output. In at least some embodiments, the replaying section replays content of the recording in response to determining that the application has priority. In at least some embodiments, in response to the recording being output, the the replaying section cause the recording section to continue recording through a buffer. In at least some embodiments, in response to the controller determining that the application has regained priority, the replaying section outputs the recording or the last condition. In at least some embodiments, radio applications replay what was missed. In at least some embodiments, map applications skip what was missed and jump straight to the most current content.

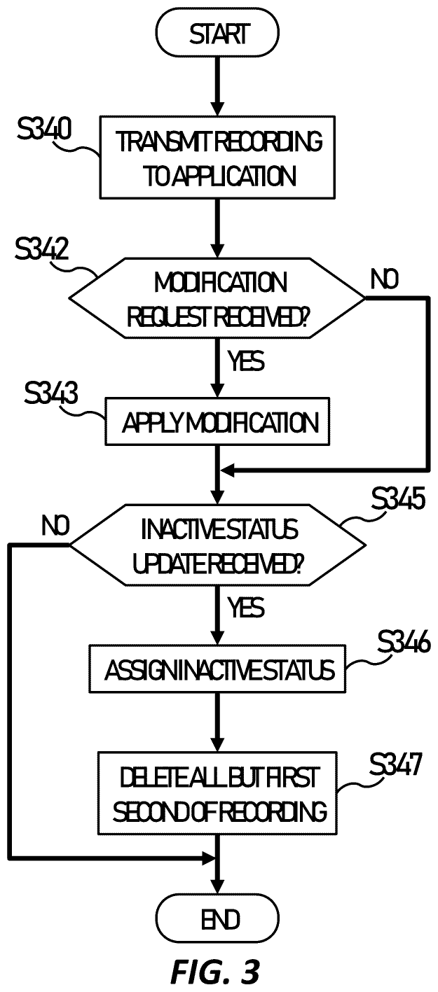

FIG. 3 is an operational flow for modifying recorded output, according to at least some embodiments of the subject disclosure. The operational flow provides a method of modifying recorded output, such as the recorded output modification at S235 of FIG. 2. In at least some embodiments, the method is performed by a controller, such as controller 402 of FIG. 4.

At S340, in at least some embodiments, a modifying section of the controller transmits the recording to the application. In at least some embodiments, the modifying section transmits the recorded output to the application over a secure communication channel established between the modifying section and the application. In at least some embodiments, the modifying section provides the application with opportunities for acquiring, modifying, updating or deleting the ongoing recording. In at least some embodiments, the modifying section does not determine how to handle recordings, such as based on individual application or application-type settings. In at least some embodiments, the arbitration manager enables the application to acquire, modify, update, or delete the recording or condition. In at least some embodiments, the operation is performed to allow the application to review its recorded output and decide on any modifications.

At S342, in at least some embodiments, the modifying section determines whether a modification request has been received from the application. In at least some embodiments, the modifying section listens for incoming requests from the application. In at least some embodiments, if a modification request is received, the modifying section captures the details of the request. In response to determining that a modification request has been received, the operational flow proceeds to modification application at S343. In response to determining that a modification request has not been received, the operational flow proceeds to inactive status determination at S345.

At S343, in at least some embodiments, the modifying section applies the modification. In at least some embodiments, the modifying section applies the specific modifications requested by the application to the recording. In at least some embodiments, the applications determines the best content to output. In at least some embodiments, the modifying section deletes all but a first second of the recording. In at least some embodiments, the modifying section maintains only a latest 5 seconds of the recording. In at least some embodiments, the modifying section deletes all content of the recording. In at least some embodiments, the modifying section modifies the recording as per the application's request as a result of this operation.

At S345, in at least some embodiments, the modifying section determines whether an inactive status update has been received. In at least some embodiments, the modifying section listens for incoming status updates from the application. In at least some embodiments, the modifying section enables each application to change a status from standby to inactive. In at least some embodiments, the modifying section captures the details of the update in response to receiving an inactive status update. In at least some embodiments, the modifying section determines the presence or absence of an inactive status update. In response to determining that an inactive status update has been received, the operational flow proceeds to inactive status assignment at S346. In response to determining that an inactive status update has not been received, the operational flow ends.

At S346, in at least some embodiments, the modifying section assigns inactive status to the application. In at least some embodiments, the modifying section changes the application's status in the system's process table. In at least some embodiments, the modifying section uses system calls to modify the process table and set the application's state to inactive. In at least some embodiments, an application ceases to generate content for output in inactive status. In at least some embodiments, this operation is performed to change the application's status to inactive when an inactive status update is received.

At S347, in at least some embodiments, the modifying section deletes all but the first second of the recording. In at least some embodiments, the modifying section trims the recording, preserving only the first second. In at least some embodiments, the modifying section uses system calls to access the buffer and apply the trimming operation. In at least some embodiments, only the first second of the recording is preserved as a result of this operation. In at least some embodiments, the modifying section deletes in response to assigning inactive status to the application. In at least some embodiments, this operation is performed to limit the length of the recording after the application has been assigned an inactive status.

FIG. 4 is a block diagram of a hardware configuration for application controlled modification of priority transition content output, according to at least some embodiments of the subject disclosure.

The exemplary hardware configuration includes head unit 400, which interacts with input device 408 directly or through network 407. In at least some embodiments, network 407 is an ethernet network, a Controller Area Network (CAN), or any other wired or wireless network or a combination thereof. In at least some embodiments, head unit 400 is a computer or other computing device that receives input or commands from input device 408. In at least some embodiments, head unit 400 is integrated with input device 408. In at least some embodiments, head unit 400 is a computer system that executes computer-readable instructions to perform operations for application controlled modification of priority transition content output.

Head unit 400 includes a controller 402, a storage unit 404, an input/output interface 406, and a communication interface 409. In at least some embodiments, controller 402 includes a processor or programmable circuitry executing instructions to cause the processor or programmable circuitry to perform operations according to the instructions. In at least some embodiments, controller 402 includes analog or digital programmable circuitry, or any combination thereof. In at least some embodiments, controller 402 includes physically separated storage or circuitry that interacts through communication. In at least some embodiments, storage unit 404 includes a non-volatile computer-readable medium capable of storing executable and non-executable data for access by controller 402 during execution of the instructions. Communication interface 409 transmits and receives data from network 407. Input/output interface 406 connects to various input and output units, such as input device 408, via a parallel port, a serial port, a keyboard port, a mouse port, a monitor port, and the like to accept commands and present information. In some embodiments, storage unit 404 is external from head unit 400.

Controller 402 includes assigning section 450, recording section 452, modifying section 454, and replaying section 456. Storage unit 404 includes status parameters 460, recordings 462, and modification parameters 464.

Assigning section 450 is the circuitry or instructions of controller 402 configured to assign status to applications. In at least some embodiments, assigning section 450 is configured to assign standby status to an application in response to determining that the application does not have priority. In at least some embodiments, assigning section 450 utilizes information in storage unit 404, such as status parameters 460. In at least some embodiments, assigning section 450 includes sub-sections for performing additional functions, as described in the foregoing flow charts. In at least some embodiments, such sub-sections are referred to by a name associated with a corresponding function.

Recording section 452 is the circuitry or instructions of controller 402 configured to record content generated by applications for output. In at least some embodiments, recording section 452 is configured to record display output and audio output generated by the application. In at least some embodiments, recording section 452 records information in storage unit 404, such as recordings 462. In at least some embodiments, recording section 452 includes sub-sections for performing additional functions, as described in the foregoing flow charts. In at least some embodiments, such sub-sections are referred to by a name associated with a corresponding function.

Modifying section 454 is the circuitry or instructions of controller 402 configured to modify recorded content. In at least some embodiments, modifying section 454 is configured to modify, in response to a request from the application, the recording of output generated by the application. In at least some embodiments, recording section 452 utilizes information in storage unit 404, such as modification parameters 464. In at least some embodiments, modifying section 454 includes sub-sections for performing additional functions, as described in the foregoing flow charts. In at least some embodiments, such sub-sections are referred to by a name associated with a corresponding function.

Replaying section 456 is the circuitry or instructions of controller 402 configured to replay recorded output or modified content. In at least some embodiments, replaying section 456 is configured to replay content of the recording in response to determining that the application has priority. In at least some embodiments, replaying section 456 utilizes information in storage unit 404, such as recordings 462. In at least some embodiments, replaying section 456 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, application controlled modification of priority transition content output is performed by determining that an application has lost priority while the application is transmitting output, assigning standby status to the application, recording display output and audio output generated by the application, modifying, in response to a request from the application, the recording of output generated by the application, and replaying content of the recording in response to determining that the application has priority.

In at least some embodiments, application controlled modification of priority transition content output is performed by further determining whether the application has the highest priority in response to deactivation of transmission. In at least some embodiments, application controlled modification of priority transition content output is performed by further transmitting the recording to the application. In at least some embodiments, the modifying includes deleting all but a first second of the recording. In at least some embodiments, the deleting is in response to assigning inactive status to the application. In at least some embodiments, wherein the modifying includes maintaining only a latest 5 seconds of the recording. In at least some embodiments, wherein the modifying includes deleting all content of the recording.

In at least some embodiments, application controlled modification of priority transition content output is performed by a processor executing instructions in accordance with the foregoing operations or a device comprising a controller including circuitry configured to perform the foregoing operations.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium including instructions that, in response to execution by one or more processors, cause performance of operations comprising:
determining that an application has lost priority while the application is transmitting output;
assigning standby status to the application;
recording display output and audio output generated by the application;
modifying, in response to a request from the application, the recording of output generated by the application;
replaying content of the recording in response to determining that the application has priority.

2. The computer-readable medium of claim 1, wherein the operations further comprise determining whether the application has priority in response to deactivation of output transmission.

3. The computer-readable medium of claim 1, wherein the operations further comprise transmitting the recording to the application.

4. The computer-readable medium of claim 1, wherein the modifying includes deleting all but a first second of the recording.

5. The computer-readable medium of claim 4, wherein the deleting is in response to assigning inactive status to the application.

6. The computer-readable medium of claim 1, wherein the modifying includes maintaining only a latest 5 seconds of the recording.

7. The computer-readable medium of claim 1, wherein the modifying includes deleting all content of the recording.

8. A method comprising:
determining that an application has lost priority while the application is transmitting output;
assigning standby status to the application;
recording display output and audio output generated by the application;
modifying, in response to a request from the application, the recording of output generated by the application;
replaying content of the recording in response to determining that the application has priority.

9. The method of claim 8, further comprising
determining whether the application has priority in response to deactivation of output transmission.

10. The method of claim 8, further comprising
transmitting the recording or condition to the application.

11. The method of claim 8, wherein the modifying includes deleting all but a first second of the recording.

12. The method of claim 11, wherein the deleting is in response to assigning inactive status to the application.

13. The method of claim 8, wherein the modifying includes maintaining only a latest 5 seconds of the recording.

14. The method of claim 8, wherein the modifying includes deleting all content of the recording.

15. A device comprising:
a controller including circuitry configured to perform operations including:
determining that an application has lost priority while the application is transmitting output;
assigning standby status to the application;
recording display output and audio output generated by the application;
modifying, in response to a request from the application, the recording of output generated by the application;
replaying content of the recording in response to determining that the application has priority.

16. The method of claim 15, further comprising
determining whether the application has priority in response to deactivation of output transmission.

17. The method of claim 15, further comprising
transmitting the recording or condition to the application.

18. The method of claim 15, wherein the modifying includes deleting all but a first second of the recording.

19. The method of claim 18, wherein the deleting is in response to assigning inactive status to the application.

20. The method of claim 15, wherein the modifying includes maintaining only a latest 5 seconds of the recording.
